(19) United States
(12) Patent Application Publication
(10) Pub. No.: US 2010/0248775 A1
(43) Pub. Date: Sep. 30, 2010

(54) MOBILE PHONE CAPABLE OF ACCESSING EXTERNAL STORAGE DEVICES

(76) Inventors: Jeffrey E. Mikkelsen, Palmyra, VA (US); Kyle S. Mikkelsen, Palmyra, VA (US)

Correspondence Address: Rene A. Vazquez, 127 South Main Street, Marlborough, CT, 06447, US

(21) Appl. No.: 12/170,103

(22) Filed: Jul. 9, 2008

Related U.S. Application Data
(60) Provisional application No. 60/929,671, filed on Jul. 9, 2007.

(51) Int. Cl. H04M 1/00

(52) U.S. Cl. 455/556.1

(57) ABSTRACT

A mobile phone that is capable of accessing external storage devices, such as USB flash drives, is provided. The mobile phone of the present invention is particularly suited for smartphones that incorporate email functionality, allowing the user to attach files stored on the external storage device to outgoing emails and store files attached to incoming emails on the external storage device.

This application claims the benefit of provisional U.S. Patent Application No. 60/929,671, filed Jul. 9, 2007. The entire disclosure of the prior application is considered as being part of the disclosure of the accompanying application and is hereby incorporated by reference therein.

### BACKGROUND OF THE INVENTION

1. Field of the Invention

The present invention relates to mobile phones and, more particularly, to a mobile phone that is adapted to access external storage devices, such as flash drives.

2. Background of the Related Art

Currently, so-called “smartphones”, which combine the features of personal digital assistants (PDAs) and mobile phones into a single device, can typically send and receive e-mails. Smartphones, such as the Blackberry®, manufactured by Research In Motion®, and the iPhone®, manufactured by Apple®, can also receive files attached to emails, such as Microsoft Word® files and Adobe® PDF files. However, current smartphones do not have the capability to access files from external storage devices, such as Universal Serial Bus (USB) flash drives.

### SUMMARY OF THE INVENTION

An object of the invention is to solve at least the above problems and/or disadvantages and to provide at least the advantages described hereinafter.

Therefore, an object of the present invention is to provide a mobile phone that is capable of accessing external storage devices, such as USB flash drives.

Another object of the present invention is to provide a mobile phone that includes an embedded data port for connecting to an external storage device having a connector compatible with the embedded data port on the mobile phone.

Another object of the present invention is to provide a mobile phone that includes a USB Type A hub port for connecting to an external storage device having a USB Type A male connector.

Another object of the present invention is to provide a mobile phone that includes a USB Type Mini-B hub port for connecting to an external storage device having a USB Type Mini-B connector.

Another object of the present invention is to provide a mobile phone that includes a USB Type Mini-A hub port for connecting to an external storage device having a USB Type Mini-A male connector.

Another object of the present invention is to provide a mobile phone that includes a wireless data transfer system for connecting to an external storage device compatible with the wireless data transfer system.

To achieve at least the above objects, in whole or in part, there is provided a mobile phone that includes a housing, a display attached to the housing, an input device attached to the housing, a speaker attached to the housing for converting an incoming electronic audio signal into sound, a microphone for converting sound into an electronic signal, a data port attached to the housing and configured to connect with an external storage device and a processor inside the housing for processing wireless communication signals to and from the mobile phone and for communicating with the external storage device.

To achieve at least the above objects, in whole or in part, there is provided a wireless communication device that includes a housing, a data port attached to the housing and configured to connect with an external storage device and a processor inside the housing for processing wireless communication signals to and from the wireless communication device and for communicating with the external storage device.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic diagram of a mobile phone with a data port for connecting to an external storage device having a connector compatible with the data port, in accordance with a first preferred embodiment of the present invention;

FIGS. 2A and 2B are schematic diagrams of a mobile phone with a USB Type A hub port for connecting to an external storage device having USB Type A connector, in accordance with a second preferred embodiment of the present invention;

FIGS. 3A and 3B are schematic diagrams of a mobile phone with a USB Type Mini-A hub port for connecting to an external storage device having USB Type Mini-A connector, in accordance with a third preferred embodiment of the present invention;

FIGS. 4A and 4B are schematic diagrams of a mobile phone with a USB Type Mini-B hub port for connecting to an external storage device having USB Type Mini-B connector, in accordance with a third preferred embodiment of the present invention; and

FIG. 5 is a schematic diagram of a mobile phone that incorporates a wireless data transfer system for connecting to an external storage device compatible with the wireless data transfer system, in accordance with a fourth preferred embodiment of the present invention.

### DETAILED DESCRIPTION OF PREFERRED EMBODIMENTS

It would be advantageous to be able to access files stored on external storage devices with a mobile phone, in order to improve the efficiency and functionality of the mobile phone. For example, a mobile phone that is capable of accessing external storage devices would give a user the option of attaching externally stored files to an email that is composed and sent with the mobile phone, as well as the option of storing files attached to incoming emails on the external storage device.

The terms “mobile phone,” “smartphone” and “wireless communication device” are used interchangeably herein, and refer to a portable electronic device used for mobile voice and data communication over a network. In addition to the standard voice functions of a telephone, current mobile phones may support many additional services and accessories, such as SMS for text messaging, email, packet switching for access to the Internet, gaming, Bluetooth communications, infrared communications, camera with video recorder and MMS for sending and receiving photos and video. Most current mobile phones connect to a cellular network of base stations (cell sites), which is in turn interconnected to the public switched telephone network (PSTN). However, the present invention can also be applied to mobile phones that utilize satellite networks or any other wireless communication network known in the art.

The terms “external storage device” and “portable storage device” are also used interchangeably and refer to storage devices that are not permanently connected to the device that accesses it, such as external hard drives, flash drives, external optical drives and the like.

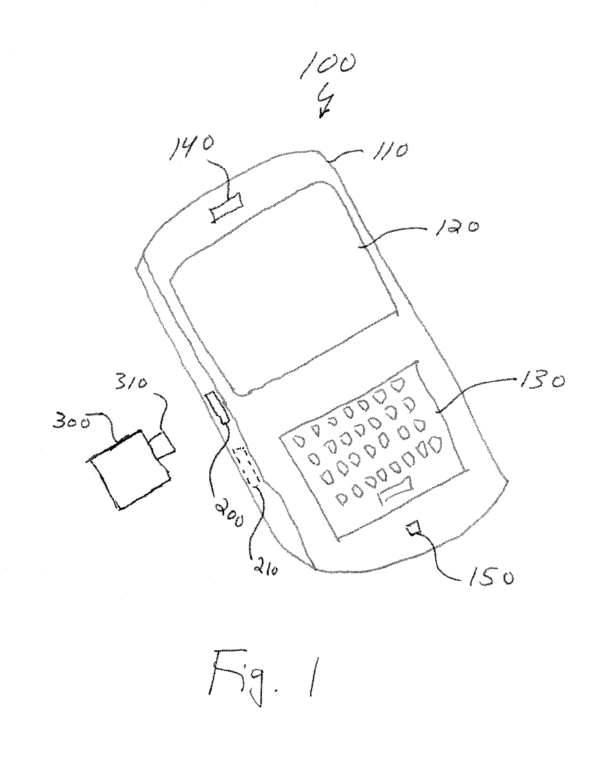

FIG. 1 is a schematic diagram of a mobile phone 100 with a data port 200 for connecting to an external storage device 300 having a connector 310 compatible with the data port 200, in accordance with a first preferred embodiment of the present invention. The mobile phone shown in FIG. 1 is a generic representation of such a device, which typically includes a main housing 110, a display 120, an input device, such as a keyboard 130, a speaker 140 for converting an incoming electronic audio signal into sound and a microphone 150 for converting sound into an electronic signal.

A microprocessor (not shown) inside the mobile phone 100 handles all of the housekeeping chores for the keyboard 130 and display 140, deals with command and control signaling with the communications network, coordinates the rest of the functions on the mobile phone 100 and runs any other applications such as, for example, an email application. The mobile phone typically also includes ROM and flash memory chips that provide storage for the phone's operating system, customizable features, such as the phone directory, as well as other applications such as, for example, an email application.

The external storage device 300 is typically a flash memory data storage device that has been integrated with a data connector 310 such as, for example, a USB connector. However, the mobile phone 100 can be adapted to accept other types of portable data storage devices by using a data port 200 that is configured to accept the connector used by the chosen data storage device 300. Further, the mobile phone 100 can optionally include additional data ports 210 that are configured to accept other types of connectors so that the mobile phone is capable of accepting more than one type of data storage device 300. Examples of other types of data storage devices include, but are not limited to, optical drives and magnetic media, such as external hard drives.

The data port 200/210 is suitably a USB data port that is compatible with the USB connectors commonly used for portable storage devices 300. However, any data port known in the art can be used while still falling within the scope of the present invention. Examples of other types of data connectors include, but are not limited to, serial advance technology attachment (Serial ATA) and FireWire.

The mobile phone 100 preferably runs code that will allow the mobile phone 100 to recognize the portable storage device 300 when it is connected to the mobile phone 100 via the data connector 200/210, allow the mobile phone 100 to access data on the portable storage device 100 and allow the mobile phone 100 to write to the portable storage device 300. The code can be incorporated into the mobile phone's operating system, or it can be stored as a separate application in ROM or flash memory.

The inclusion of a data port 200, 210 that is compatible with commonly used portable data storage devices 300 can greatly enhance the functionality of the mobile phone 100. For example, if the mobile phone 100 includes email functionality, files stored on the portable storage device 300 can be accessed by the mobile phone 100 for attachment to an email being sent by a user. Similarly, attachments received on the mobile phone 100 via email, such as files and pictures, may be stored on the portable storage device 300. Another example of added functionality is the storage of specialized applications on the portable storage device that can be accessed and run by the mobile phone 100 when the portable storage device 300 is connected to the mobile phone 100.

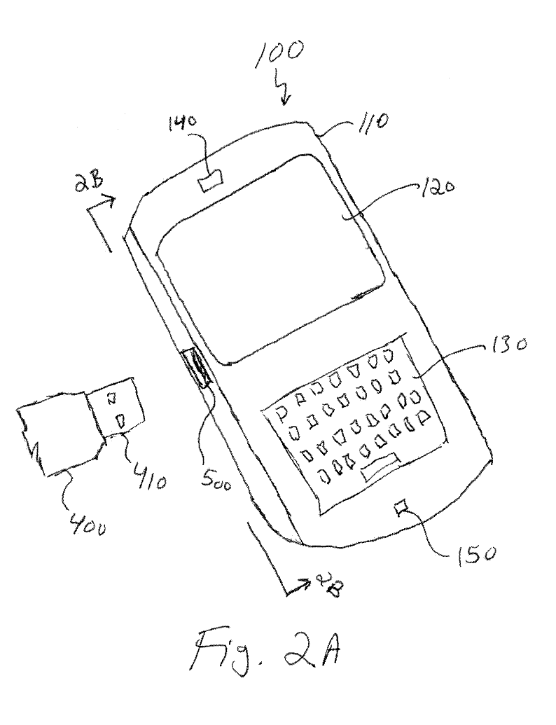

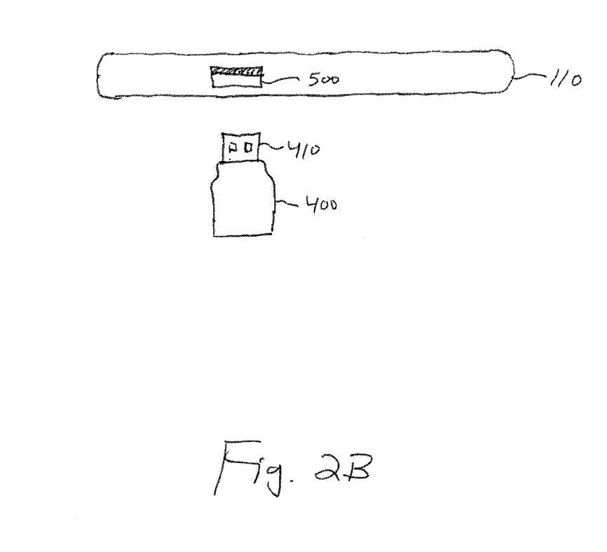

As discussed above, any type of data port 200/210 can be used while still falling within the scope of the present invention. Because USB flash drives are common and well known portable storage devices, several preferred embodiments incorporating USB connectors are shown in FIGS. 2A-4B. The mobile phone shown in FIGS. 2A and 2B incorporate a USB Type A hub port 500 that is compatible with a personal storage device 400 that includes a USB Type A connector 410. FIG. 2B is a side view of the mobile phone 100 of FIG. 2A along the view line 2B-2B.

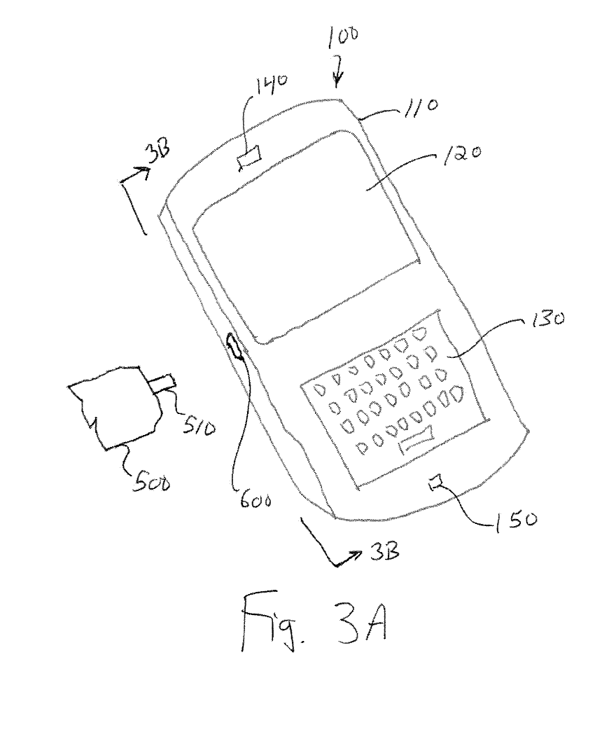

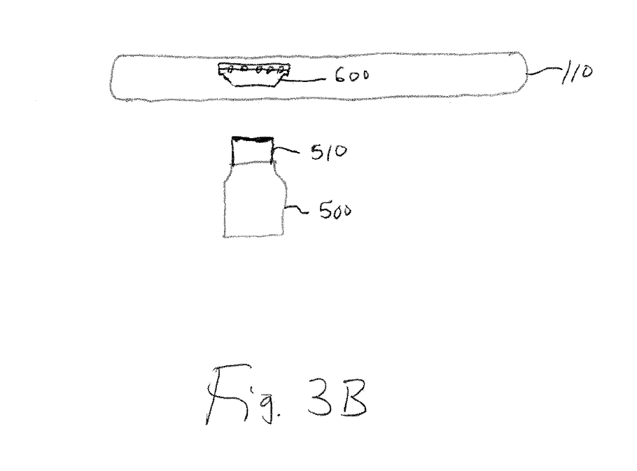

The mobile phone 100 shown in FIGS. 3A and 3B incorporate a USB Type Mini-A hub port 600 that is compatible with a personal storage device 500 that includes a USB Type Mini-A connector 510. FIG. 2B is a side view of the mobile phone 100 of FIG. 3A along the view line 3B-3B.

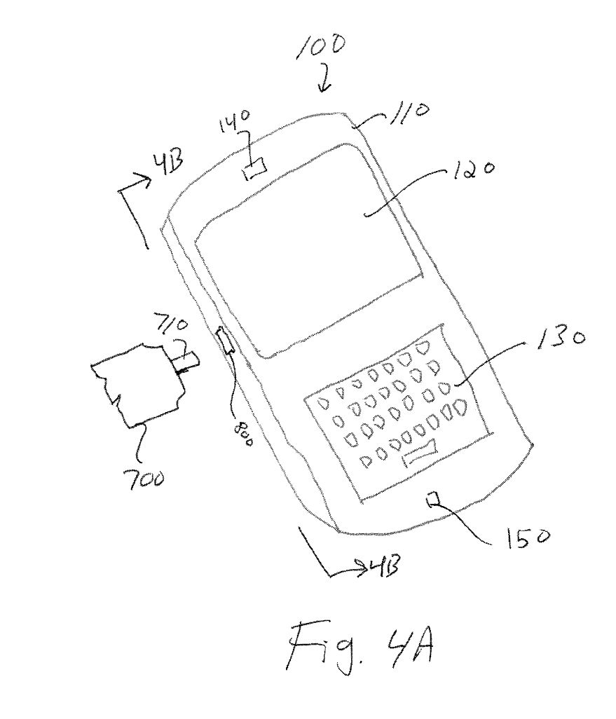

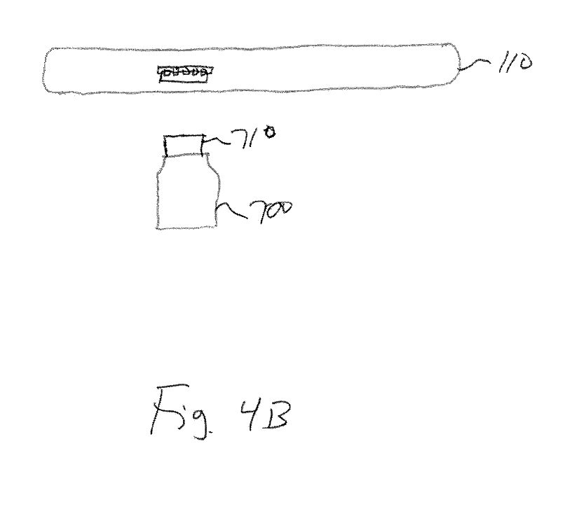

The mobile phone 100 shown in FIGS. 4A and 4B incorporate a USB Type Mini-B hub port 800 that is compatible with a personal storage device 700 that includes a USB Type Mini-B connector 410. FIG. 4B is a side view of the mobile phone 100 of FIG. 4A along the view line 4B-4B.

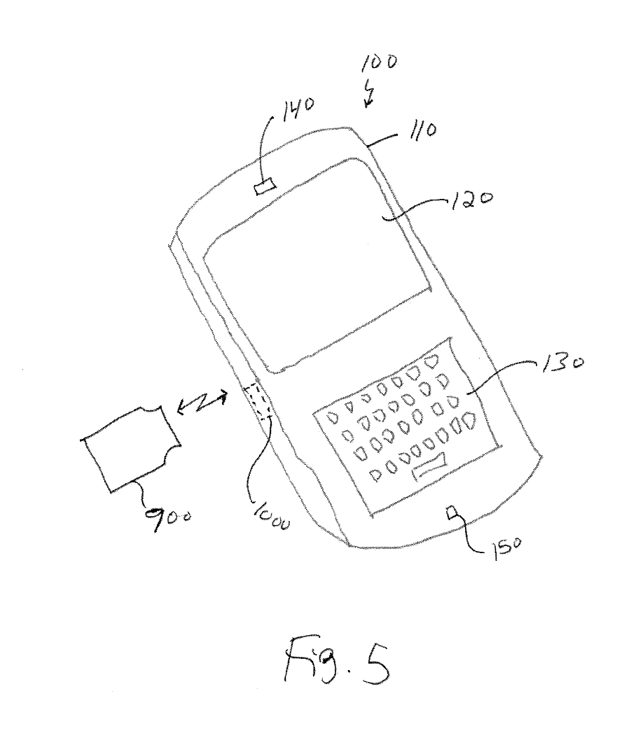

The mobile phone 100 may also be equipped with a wireless data transfer system for accessing portable storage devices that are compatible with the wireless data transfer system. This is schematically shown in the embodiment of FIG. 5, which includes a wireless data transfer system 1000 for accessing a portable storage device 900 that is compatible with the wireless data transfer system 1000. Examples of wireless protocols for the wireless data transfer system 1000 include, but are not limited to, wireless USB, Bluetooth and infrared.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. For example, although data ports 200, 210, 500, 600, 800 and 1000 are shown as being located on the side of the housing 110, it should be appreciated that these ports can be located anywhere on the housing while still falling within the scope of the present invention. Various changes may be made without departing from the spirit and scope of the invention, as defined in the following claims.

What is claimed is:

1. A mobile phone, comprising:
a housing;
a display attached to the housing;
an input device attached to the housing;
a speaker attached to the housing for converting an incoming electronic audio signal into sound;
a microphone for converting sound into an electronic signal;
a data port attached to the housing and configured to connect with an external storage device; and
a processor inside the housing for processing wireless communication signals to and from the mobile phone and for communicating with the external storage device.

2. The mobile phone of claim 1, wherein the data port comprises a USB Type A hub port.

3. The mobile phone of claim 1, wherein the data port comprises a USB Type Mini-A hub port.

4. The mobile phone of claim 1, wherein the data port comprises a USB Type Mini-B hub port.

5. The mobile phone of claim 1, wherein the data port comprises a wireless data transfer system.

6. The mobile phone of claim 5, wherein the wireless data transfer system comprises a wireless USB system.

7. The mobile phone of claim 5, wherein the wireless data transfer system comprises a Bluetooth data transfer system.

8. The mobile phone of claim 5, wherein the wireless data transfer system comprises an infrared data transfer system.

9. The mobile phone of claim 1, wherein the data port is configured to connect with a flash drive.

10. The mobile phone of claim 1, wherein the data port is configured to connect with a USB flash drive.

11. A wireless communication device, comprising:
a housing;
a data port attached to the housing and configured to connect with an external storage device; and
a processor inside the housing for processing wireless communication signals to and from the wireless communication device and for communicating with the external storage device.

12. The device of claim 11, wherein the data port comprises a USB Type A hub port.

13. The device of claim 11, wherein the data port comprises a USB Type Mini-A hub port.

14. The device of claim 11, wherein the data port comprises a USB Type Mini-B hub port.

15. The device of claim 11, wherein the data port comprises a wireless data transfer system.

16. The device of claim 15, wherein the wireless data transfer system comprises a wireless USB system.

17. The device of claim 15, wherein the wireless data transfer system comprises a Bluetooth data transfer system.

18. The device of claim 15, wherein the wireless data transfer system comprises an infrared data transfer system.

19. The device of claim 11, wherein the data port is configured to connect with a flash drive.

20. The device of claim 11, wherein the data port is configured to connect with a USB flash drive.
